(19) United States
(12) Patent Application Publication
(10) Pub. No.: US 2021/0026322 A1
(43) Pub. Date: Jan. 28, 2021

(54) DETECTION DEVICE FOR SPINDLE OF MACHINE TOOL AND DETECTION METHOD FOR SPINDLE OF MACHINE TOOL

(71) Applicant: INDUSTRIAL TECHNOLOGY RESEARCH INSTITUTE, Hsinchu (TW)

(72) Inventors: Sheng-Ming MA, Taichung City (TW); Yu-Sheng LAI, Taichung City (TW); Wei-Jen WU, Taoyuan City (TW); Ta-Jen PENG, Taichung City (TW); Tzuo-Liang LUO, Taichung City (TW)

(73) Assignee: INDUSTRIAL TECHNOLOGY RESEARCH INSTITUTE, Hsinchu (TW)

(21) Appl. No.: 16/692,904

(22) Filed: Nov. 22, 2019

(30) Foreign Application Priority Data
Jul. 24, 2019 (TW) 108126087

(51) Int. Cl. G05B 19/4065; B23Q 17/09; B23Q 17/22

(52) U.S. Cl. CPC G05B 19/4065; B23Q 17/22; B23Q 17/0904

(57) ABSTRACT

A detection device for a spindle of a machine tool is provided, wherein the spindle includes an insertion hole. The detection device includes a contact housing, a main housing, a sensor, and a process module. The contact housing has a first chamber, and the first chamber has an inner surface. The main housing is connected to the contact housing, and has a second chamber communicated with the first chamber. The sensor is disposed in the first chamber and connected to the inner surface. The process module is disposed in the second chamber and electrically connected to the sensor. When the contact housing is inserted into the insertion hole of the spindle, the sensor is configured to detect the deformation of the contact housing and generate a detection signal. The process module generates a determination signal according to the detection signal.

### CROSS REFERENCE TO RELATED APPLICATIONS

This application claims the benefit of Taiwan Patent Application No. 108126087, filed Jul. 24, 2019, the entirety of which is incorporated by reference herein.

### BACKGROUND

### Field of the Invention

The application relates in general to a detection device and a detection method, and in particular, to a detection device for a spindle of a machine tool and a detection method for a spindle of a machine tool.

### Description of the Related Art

A machine tool used for cutting or drilling generally has a spindle, and a cutter is detachably disposed on the spindle. The spindle can be used to rotate the cutter, and the rotation of the cutter allows the cutter to cut or drill a target.

However, since the cutter wears during use, it is necessary to change the cutter frequently. Some debris generated from cutting or drilling may enter the spindle during the cutter replacement process. When a new cutter is installed in the spindle, the cutter may tilt due to the debris between the cutter and the spindle, and a large amount of vibration may be caused when the tool rotates. Therefore, the spindle can become damaged.

A general detection method is to apply a test lacquer to the surface of the cutter, and insert the tool into the spindle and pull it out. The presence of debris can be detected by whether the test lacquer on the cutter is scraped off by the spindle. However, the aforementioned detection method is not accurate. The user can often make misjudgments using the aforementioned detection method. Therefore, it is necessary to provide an improved detection method for the spindle of the machine tool.

### SUMMARY

The disclosure provides a detection device for a spindle of a machine tool. The detection device can detect the spindle of the machine tool immediately, so as to prevent a cutter from being disposed on a spindle that is in a bad condition, as doing so may damage the spindle or influence the production yield of the product produced by the machine tool.

The disclosure provides a detection device for a spindle of a machine tool, wherein the spindle includes an insertion hole. The detection device includes a contact housing, a main housing, a sensor, and a process module. The contact housing has a first chamber, and the first chamber has an inner surface. The main housing is connected to the contact housing, and has a second chamber communicated with the first chamber. The sensor is disposed in the first chamber and connected to the inner surface. The process module is disposed in the second chamber and electrically connected to the sensor. When the contact housing is inserted into the insertion hole of the spindle, the sensor is configured to detect the deformation of the contact housing and generate a detection signal. The process module generates a determination signal according to the detection signal.

In some embodiments, the contact housing has a conical structure. The insertion hole has a connecting surface, and the contact housing has an outer surface. In some embodiments, when the contact housing is inserted into the insertion hole, the outer surface contacts the connecting surface.

In some embodiments, the process module obtains a contact ratio according to the detection signal and the quantized data. The contact ratio corresponds to the contact area between the outer surface and the connecting surface. In some embodiments, the connecting surface and the outer surface are conical.

In some embodiments, the detection device for the spindle of the machine tool further includes a display module. The display module is electrically connected to the process module, and configured to display a display signal corresponding to the determination signal.

In some embodiments, the detection device for the spindle of the machine tool further includes a wireless transmission module. The wireless transmission module is electrically connected to the process module, and configured to transmit the determination signal in a wireless manner.

In some embodiments, the detection device for the spindle of the machine tool further includes a tool-clamped member disposed on the contact housing. When the contact housing is inserted into the insertion hole, the tool-clamped member is buckled into the insertion hole.

In some embodiments, the sensor is a strain sensor, and the resistance of the sensor corresponds to the deformation. The sensor has a longitudinal structure extending along an annular path.

The disclosure provides a detection method for a spindle of a machine tool, comprising: inserting a detection device into the spindle of the machine tool; using the detection device to detect the deformation of the contact housing of the detection device and to generate a detecting signal; and using a process module to obtain the contact ratio according to the detection signal and the quantized data.

In some embodiments, the quantized data is obtained in the following steps: inserting a first detection device having a first contact housing into the spindle, detecting the first contact housing with a sensor of the first detection device, and obtaining a first deformation, wherein the first contact housing and a connecting surface of the spindle have a first contact ratio; inserting a second detection device having a second contact housing into the spindle, detecting the second contact housing with a sensor of the second detection device, and obtaining a second deformation, wherein the second contact housing and the connecting surface of the spindle have a second contact ratio; and forming the quantized data according to the first contact ratio, the first deformation, the second contact ratio, and the second deformation.

In some embodiments, the contact ratios are equivalent values of the deformations. In some embodiments, the detection module obtains a determination signal according to the contact ratio.

In summary, the detection device of the disclosure can detect the spindle of the machine tool immediately, so as to reduce the probability of damage of the spindle, or improve the production yield of the machine tool.

### BRIEF DESCRIPTION OF DRAWINGS

The invention can be more fully understood by reading the subsequent detailed description and examples with references made to the accompanying drawings, wherein:

FIG. 1 is an exploded-view diagram of a machine tool and a detection device according to some embodiments of the disclosure;

FIG. 2 is a front view of the detection device according to some embodiments of the disclosure;

FIG. 3 is a bottom view of the contact housing and the sensors according to some embodiments of the disclosure;

FIG. 4 is a schematic diagram of the detection device in a detection process; and

FIG. 5 is a relation diagram of the contact ratio and the deformation of the quantized data.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Spatially relative terms, such as upper and lower, may be used herein for ease of description to describe one element or feature's relationship to other elements or features as illustrated in the figures. The spatially relative terms are intended to encompass different orientations of the device in use or operation in addition to the orientation depicted in the figures. Moreover, the shape, size, thickness, and angle of inclination depicted in the drawings may not be drawn to scale or may be simplified for clarity of discussion; these drawings are merely intended for illustration.

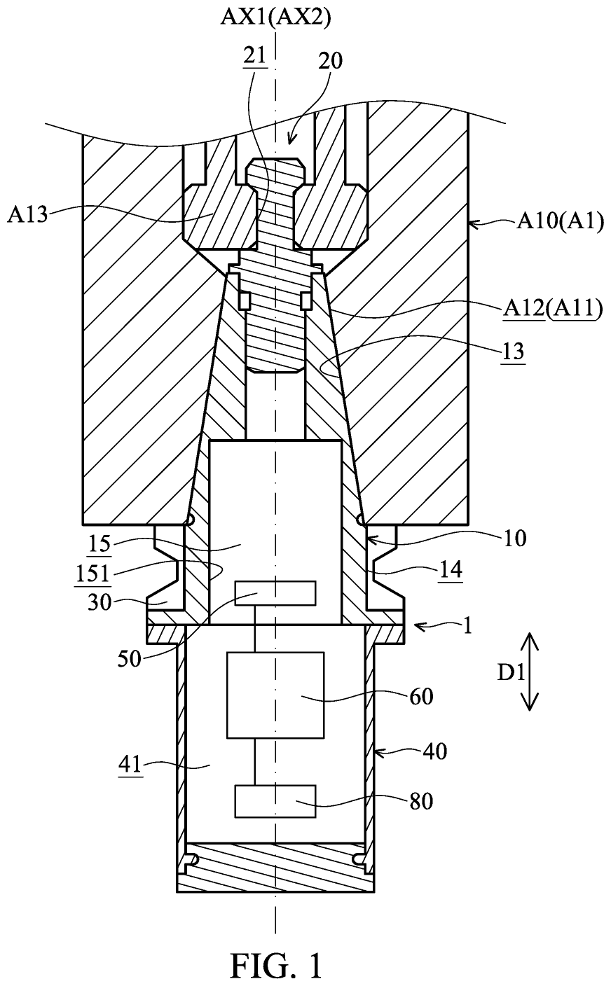

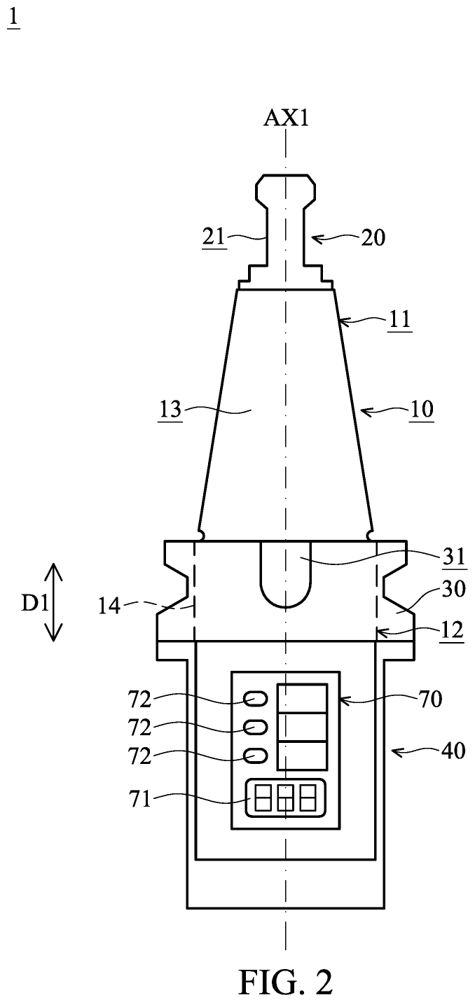

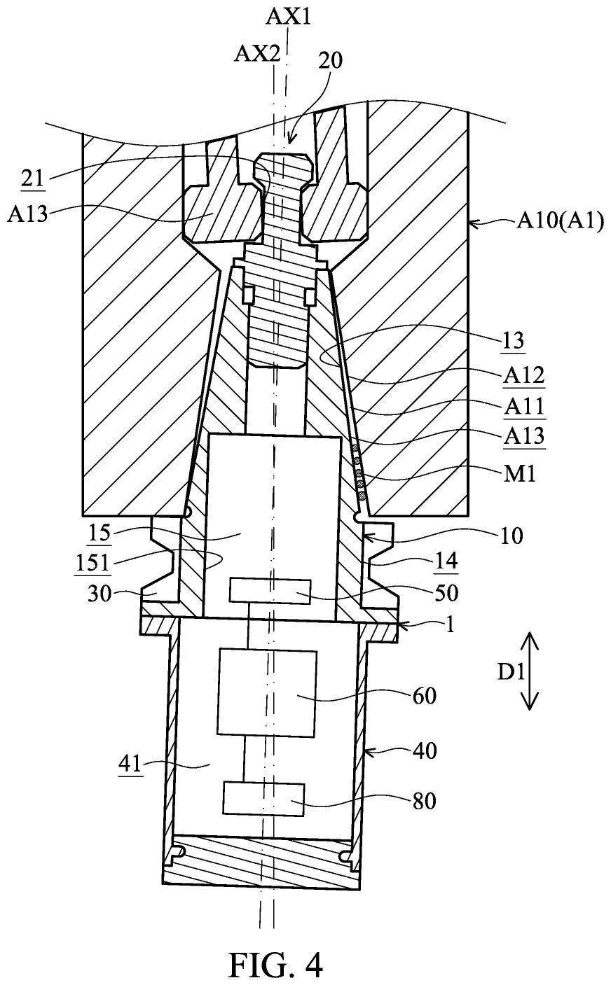

FIG. 1 is an exploded-view diagram of a machine tool A1 and a detection device 1 according to some embodiments of the disclosure. FIG. 2 is a front view of the detection device 1 according to some embodiments of the disclosure. The machine tool A1 can be a cutting machine or a drilling machine, but is not limited thereto. The machine tool A1 includes a spindle A10. A cutter (not shown) can be inserted into an insertion hole A11 of the spindle A10, and the machine tool A1 can rotate the cutter via the spindle A10. The cutter is used to cut or drill a target. Therefore, if a connecting surface A12 of the insertion hole A11 connected to the cutter has worn down, or debris M1 (such as iron debris) is attached on the connecting surface A12 (as shown in FIG. 4), the cutter cannot connect to the spindle A10 properly. When the spindle A10 rotates the cutter, the cutter vibrates, and the cutter cannot be aligned with the target to process, or the spindle A10 may break.

The detection device 1 is configured to be inserted into the spindle A10 of the machine tool A1, and determine the connecting surface A12 of the insertion hole A11 is in good condition or not, or determine if there is any debris M1 (such as iron debris) attached in the insertion hole A11.

The detection device 1 includes a contact housing 10, a tool-clamped member 20, a positioning member 30, a main housing 40, a plurality of sensors 50, and a process module 60. The contact housing 10 has a conical structure. The contact housing 10 can be made of metal, such as steel. When the detection device 1 is inserted into the insertion hole A11 of the spindle A10, the contact housing 10 contacts the insertion hole A11.

The contact housing 10 has a sharp end 11 and an engaged end 12. The contact housing 10 is tapered from the engaged end 12 to the sharp end 11. The contact housing 10 is extended along a central axis AX1, and can rotate around the central axis AX1. In other words, the central axis AX1 can pass through the center of the contact housing 10. Furthermore, the central axis AX1 can pass through the center of the sharp end 11 and the center of the engaged end 12.

The contact housing 10 has a hollow structure. The contact housing 10 includes an outer surface 13 an extending surface 14, and a first chamber 15. The appearance of outer surface 13 corresponds to the appearance of the connecting surface A12. When the detecting device 1 is inserted into the insertion hole A11 of the spindle A10, the outer surface 13 contacts the connecting surface A12. In this embodiment, both the connecting surface A12 and the outer surface 13 are conical. The diameter of the outer surface 13 can be reduced from the engaged end 12 to the sharp end 11. The extending surface 14 is connected to the outer surface 13. The extending surface 14 is annular and has a cylinder structure. The extending surface 14 can be extended along an extending direction D1. When the detection device 1 is inserted into the insertion hole A11 of the spindle A10, the extending surface 14 is disposed outside of the insertion hole A11.

The first chamber 15 has an inner surface 151. The first chamber 15 and the inner surface 151 are cylindrical and extended along the extending direction D1. The central axis AX1 passes through the center of the first chamber 15. In this embodiment, the outer surface 13 and the extending surface 14 surround the first chamber 15.

The tool-clamped member 20 is disposed on the sharp end 11 of the contact housing 10. When the detection device 1 is inserted into the insertion hole A11 of the spindle A10, the tool-clamped member 20 buckles in the insertion hole A11. In this embodiment, the main axis A10 has a locking member A13, and the tool-clamped member 20 has a buckle recess 21. When the detection device 1 is inserted into the insertion hole A11 of the spindle A10, the locking member A13 is disposed in the buckle recess 21. The detection device 1 can be detachably disposed in the spindle A10 by the tool-clamped member 20 and the locking member A13. Furthermore, the locking member A13 can provide a pulling force to the tool-clamped member 20, so that the outer surface 13 can be tightly attached to the connecting surface A12.

The positioning member 30 is disposed on the contact housing 10. In this embodiment, the positioning member 30 surrounds the extending surface 14 and connects thereto. The positioning member 30 has a cylinder structure. In this embodiment, the positioning member 30 includes a positioning slot 31. When the detection device 1 is inserted into the insertion hole A11 of the spindle A10, the positioning member 30 abuts the spindle A10, and a portion of the spindle A10 is disposed in the positioning slot 31, so as to restrict the rotation between the detection device 1 and the spindle A10.

The contact housing 10, the tool-clamped member 20 and/or the positioning member 30 of the detection device 1 can correspond to the contact housing 10, the tool-clamped member 20 and/or the positioning member 30 of a cutter.

The main housing 40 is disposed on the engaged end 12 of the contact housing 10. The main housing 40 can be extended along the extending direction D1. The main housing 40 can be a hollow structure. The main housing 40 has a second chamber 41 communicated with the first chamber 15. The first chamber 15 is cylindrical, and the central axis AX1 passes through the center of the first chamber 15.

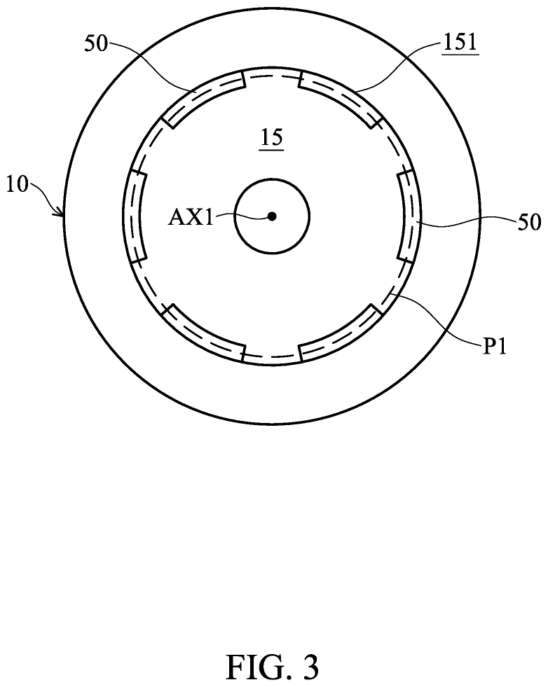

FIG. 3 is a bottom view of the contact housing 10 and the sensors 50 according to some embodiments of the disclosure. The sensors 50 are disposed in the first chamber 15 and connected to the inner surface 151. Each of the sensors 50 has a longitudinal structure, and is extended along an annular path P1. In this embodiment, a plurality of sensors 50 are arranged along the annular path P1 at intervals. The annular path P1 is disposed on a plane perpendicular to the central axis AX1.

FIG. 3 illustrates six sensors 50, however, the number of the sensors is not limited thereto. The detection device 1 can include one or more sensors 50. In some embodiments, the sensor 50 can have an annular structure extending along the annular path P1. The detection device 1 can include two sensors 50 or more than three sensors 50.

In this embodiment, the sensors 50 are adjacent to the engaged end 12. However, the positions of the sensors 50 on the inner surface 15 are not limited. In some embodiments, the sensors 50 are disposed between the sharp end 11 and the engaged end 12. In some embodiments, the detection device 1 can include a plurality of sensors 50 arranged on the inner surface 151 along the extending direction D1.

The process module 60 is disposed in the second chamber 41 and electrically connected to the sensors 50. In some embodiments, the process module 60 includes a process chip and a circuit board. The process chip can be disposed on the circuit board. When the contact housing 10 is inserted into the insertion hole A11 of the spindle A10, the sensors 50 are configured to detect a deformation of the contact housing 10 and generate a detection signal. The process module 60 can generate a determination signal according to the detection signal.

In this embodiment, when the contact housing 10 is inserted into the insertion hole A11 of the spindle A10, the locking member A13 applies the pulling force to the tool-clamped member 20. Therefore, the outer surface 13 abuts the connecting surface A12 of the insertion hole A11, and the contact housing 10 is deformed. Since the sensors 50 are affixed to the inner surface 151 of the contact housing 10, the deformation of the contact housing 10 causes the sensors 50 to be deformed. In this embodiment, each of the sensors 50 can be a strain sensor. The deformation of the contact housing 50 causes the change of the length of the sensor 50, and the change of the length of the sensor 50 causes the change of the resistance of the sensor 50. Therefore, the deformation of the contact housing 10 can be obtained by detecting the resistance of the sensor 50. In other words, the detection signal corresponds to the resistance of the sensor 50. The process module 60 derives the deformation of the contact housing 10 according to the resistance of the sensor 50, and generates the determination signal.

In FIG. 1, the spindle A10 is in good condition. There is no debris M1 disposed between the connecting surface A12 of the insertion hole A11 and the outer surface 13 of the contact housing 10. Moreover, the connecting surface A12 of the insertion hole A11 is finely attached to the outer surface 13. In this condition, the a rotation axis AX2 of the spindle A10 coincides with the central axis AX1 of the detection device 1, so that the spindle A10 can stably drive the detection device 1 to rotate around the rotation axis AX2.

FIG. 4 is a schematic diagram of the detection device 1 in a detection process. In FIG. 4, the spindle A10 is in a bad condition. As shown in FIG. 4, debris M1 are attached to the connecting surface A12 of the insertion hole A11 of the spindle A10, so that the detection device 1 is inclined relative to the insertion hole A11, and a portion of the outer surface 13 is separated from the connecting surface A12. In other words, the central axis AX1 of the detection device 1 is inclined relative to the rotation axis AX2 of the spindle A10. In some embodiments, the connecting surface A12 of the insertion hole A11 of the spindle A10 has worn down, or the connecting surface A12 has flaws. This may also cause a portion of the outer surface 13 to become separated from the connecting surface A12, or the central axis AX1 of the detection device 1 to become inclined relative to the rotation axis AX2 of the spindle A10.

In this embodiment, since a portion of the outer surface 13 is separated from the connecting surface A12 in FIG. 4, the deformation of the contact housing 10 generated from the pulling force of the locking member A13 in FIG. 4 is different from the deformation of the contact housing 10 generated from the pulling force of the locking member A13 in FIG. 1. Furthermore, the resistance of the sensor 50 in FIG. 4 is different from that in FIG. 1. Therefore, the process module 60 can determine the condition of the spindle A10 (for example, in good condition or in bad condition) according to the resistance (detection signal) of the sensor 50.

Generally, when the size or the number of the debris M1 is larger, or the flaws of the connecting surface A12 is larger, the angle between the central axis AX1 of the detection device 1 and the rotation axis AX2 of the spindle A10 is larger, or the contact ratio of the outer surface 13 to the connecting surface A12 is smaller. In this condition, if the user mounts a cutter on the spindle A10 and the spindle A10 rotates the cutter, the cutter will greatly vibrate. Thus, the cutter cannot be aligned with the target to process, or the spindle A10 may break.

In this embodiment, in order to accurately measure the condition of the spindle A10, the process module 60 can obtain a contact ratio according to the detection signal and the quantized data. The determination signal can include the contact ratio. The contact ratio corresponds to the contact area between the outer surface 13 and the connecting surface A12. In this embodiment, the contact ratio can be the ratio of the contact area to the outer surface 13. For example, when the contact ratio is 100%, it represents that the outer surface 13 completely contacts the connecting surface A12. When the contact ratio is 80%, it represents that 20% of the area of the outer surface 13 does not contact the connecting surface A12. When the contact ratio is 60%, it represents that 40% of the area of the outer surface 13 does not contact the connecting surface A12.

For example, when the spindle A10 is in good condition, the central axis AX1 coincides with the rotation axis AX2. The contact ratio is in a good range, wherein the good range is between the 75%-100%. When the spindle A10 is in a normal condition, the contact ratio is in an acceptable range, wherein the acceptable range is between the 50%-100%. When the spindle A10 is in good condition or in the acceptable range, the user does not need to maintain or clean the spindle A10.

For example, when the spindle A10 is in bad condition, the central axis AX1 is inclined relative to the rotation axis AX2. The contact ratio is in a bad range, wherein the bad range is between 0% and 50%. The user should maintain or clean the spindle A10 immediately.

In some embodiments, the quantized data can be obtained by measuring. First, the user can provide contact housings having different contact ratios relative to the connecting surface A12 of the spindle A10 (for example, a first contact housing, a second contact housing, the third contact housing, the fourth contact housing, and the fifth contact housing). In some embodiments, the contact housings using in the quantized data can be standard members. For example, the user can provide a first contact housing having a first contact ratio (such as 100% contact ratio) relative to the connecting surface A12 of the spindle A10, a second contact housing having a second contact ratio (such as 75% contact ratio) relative to the connecting surface A12 of the spindle A10, a third contact housing having a third contact ratio (such as 50% contact ratio) relative to the connecting surface A12 of the spindle A10, a fourth contact housing having a fourth contact ratio (such as 25% contact ratio) relative to the connecting surface A12 of the spindle A10, and a fifth contact housing having a fifth contact ratio (such as 0% contact ratio) relative to the connecting surface A12 of the spindle A10.

Subsequently, the detection device 1 having the first contact housing can be inserted into the insertion hole A11 measure and obtain a first resistance (or a first deformation) of the sensor 50. The detection device 1 having the second contact housing can be inserted into the insertion hole A11 measure and obtain a second resistance (or a second deformation) of the sensor 50. The detection device 1 having the third contact housing can be inserted into the insertion hole A11, measure and obtain a third resistance (or a third deformation) of the sensor 50. The detection device 1 having the fourth contact housing can be inserted into the insertion hole A11, measure and obtain a fourth resistance (or a fourth deformation) of the sensor 50. The detection device 1 having the fifth contact housing can be inserted into the insertion hole A11, measure and obtain a fifth resistance (or a fifth deformation) of the sensor 50.

In this embodiment, the quantized data can be formed by the first resistance (the first deformation) corresponding to the first contact ratio, the second resistance (the second deformation) corresponding to the second contact ratio, the third resistance (the third deformation) corresponding to the third contact ratio, the fourth resistance (the fourth deformation) corresponding to the fourth contact ratio, and the fifth resistance (the fifth deformation) corresponding to the fifth contact ratio.

Therefore, when the user actually uses the detection device 1 to inspect a spindle A10, he can compare the the resistances (or the deformations) corresponding to the detection signal to the first resistance (or deformation), the second resistance (or deformation), the third resistance (or deformation), the fourth resistance (or deformation), and the fifth resistance (or deformation). Therefore, the contact ratio of the outer surface 13 of the contact housing 10 to the connecting surface A12 of the spindle A10 can be derived.

In some embodiments, a formula can be formed by the quantized data, which is obtained by measuring. The quantized data can be obtained by the formula of the contact ratio and the resistivity (or the deformation) of the sensor 50. The contact ratios are equivalent values of the deformations. In some embodiments, the resistivity (or deformation) of the sensor 50 is proportional to the contact ratio.

In some embodiments, the quantized data can be formed by at least two contact housings having different contact ratios and the resistances (the deformation) corresponding thereto.

Therefore, when the process module 60 analyzes the detection signal, the resistivity (or the deformation) can be obtained. Subsequently, the process module 60 can compare the resistivity of the sensor 50 and the quantized data to derive the contact ratio of the outer surface 13 of the contact housing 10 to the connecting surface A12 of the spindle A10.

In some embodiments, the determination signal further includes a determination value. The process module 60 can generate the determination value according to the contact ratio. For example, the determination value corresponds to a good condition, an acceptable condition, or a bad condition of the spindle A10. When the contact ratio is greater than 75%, the determination value can be 1 corresponding to a good condition of the spindle A10. When the contact ratio is in 50%-75%, the determination value can be 2 corresponding to an acceptable condition of the spindle A10. When the contact ratio is less than 50%, the determination value can be 3 corresponding to a bad condition of the spindle A10.

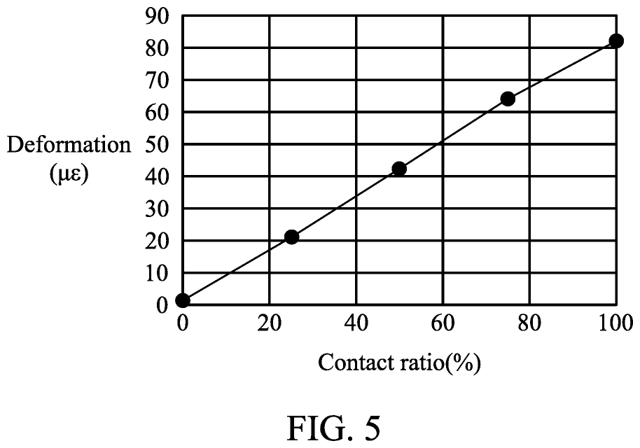

For example, as shown in FIG. 5, the first contact ratio is 100%, the measured deformation is 82.72με; the second contact ratio is 75%, the measured deformation is 64.74με; the third contact ratio is 50%, the measured deformation is 72.83με; the fourth contact ratio is 25%, the measured deformation is 21.22με; and the fifth contact ratio is 0%, the measured deformation is 1.31με. According to the aforementioned values, a formula can be obtained:

y=0.8254x+1.296

Afterward, the contact ratio of the spindle can be calculated by the deformation of the spindle and the formula, wherein the deformation of the spindle is measured by detection device 1, and the formula is obtained by the process module 60 via the quantized data. For example, when the deformation of the spindle measured by the detection device 1 is 77.65με, the contact ratio calculated by the process module 60 is 92.51%.

As shown in FIGS. 1 and 2, the detection device 1 can further include a display module 70 and a wireless transmission module 80. The display module 70 is electrically connected to the process module 60, and configured to display a display signal corresponding to the determination signal. In some embodiments, the display module 70 includes a display panel 71. The display panel 71 is configured to display a display picture corresponding to the determination signal. In some embodiments, the display module 70 includes a display device. The display module 70 is configured to display a display picture corresponding to the determination signal. The display picture shows the contact ratio of the outer surface 13 of the contact housing 10 to the connecting surface A12 of the spindle A10.

In some embodiments, the display module 70 includes a plurality of determination lights 72. The display module 70 open or close at least one determination light 72 according to the determination value of the determination signal. The determination lights 72 correspond to a good condition, an acceptable condition, or a bad condition of the spindle A10. Therefore, the user can immediately notice the condition of the spindle A10 by the display module 70, and determine whether the spindle A10 has to be maintained or cleaned.

The wireless transmission module 80 is electrically connected to the process module 60, and configured to transmit the determination signal in a wireless manner. For example, the wireless transmission module 80 can generate a wireless signal corresponding to the determination signal. An external terminal device (not shown) can receive the wireless signal. In some embodiments, the external terminal device can be a computer, a server, or a portable electronic device. Therefore, owing to the wireless transmission module 80, the user can record and analyze the spindles A10 of different machine tools A1 from the external terminal device.

In summary, the detection device of the disclosure can detect the spindle of the machine tool immediately, so as to reduce the probability of damage of the spindle, or improve the production yield of the machine tool.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A detection device for a spindle of a machine tool, wherein the spindle has an insertion hole, and the detection device comprises:
a contact housing, having a first chamber, wherein the first chamber has an inner surface;
a main housing, connected to the contact housing, wherein the main housing has a second chamber communicated with the first chamber;
a sensor, disposed in the first chamber and connected to the inner surface; and
a process module, disposed in the second chamber and electrically connected to the sensor,
wherein when the contact housing is inserted into the insertion hole, the sensor is configured to detect deformation of the contact housing and generates a detection signal, and the process module generates a determination signal according to the detection signal.

2. The detection device for the spindle of the machine tool as claimed in claim 1, wherein the contact housing has a conical structure.

3. The detection device for the spindle of the machine tool as claimed in claim 1, wherein the insertion hole has a connecting surface, and the contact housing has an outer surface, wherein when the contact housing is inserted into the insertion hole, the outer surface contacts the connecting surface.

4. The detection device for the spindle of the machine tool as claimed in claim 3, wherein the process module obtains a contact ratio according to the detection signal and a quantized data, wherein the contact ratio corresponds to the contact area between the outer surface and the connecting surface.

5. The detection device for the spindle of the machine tool as claimed in claim 3, wherein the connecting surface and the outer surface are conical.

6. The detection device for the spindle of the machine tool as claimed in claim 1, further comprising a display module electrically connected to the process module, wherein the display module is configured to display a display signal corresponding to the determination signal.

7. The detection device for the spindle of the machine tool as claimed in claim 1, further comprising a wireless transmission module electrically connected to the process module, wherein the wireless transmission module is configured to transmit the determination signal in a wireless manner.

8. The detection device for the spindle of the machine tool as claimed in claim 1, further comprising a tool-clamped member disposed on the contact housing, wherein when the contact housing is inserted into the insertion hole, the tool-clamped member is buckled into the insertion hole.

9. The detection device for the spindle of the machine tool as claimed in claim 1, wherein the sensor is a strain sensor, and the resistance of the sensor corresponds to the deformation.

10. The detection device for the spindle of the machine tool as claimed in claim 1, wherein the sensor has a longitudinal structure extending along an annular path.

11. A detection method for a spindle of a machine tool, comprising:
inserting a detection device into the spindle of the machine tool;
using the detection device to detect deformation of a contact housing of the detection device and to generate a detecting signal; and
using a process module to obtain a contact ratio according to the detection signal and a quantized data.

12. The detection method for the spindle of the machine tool as claimed in claim 11, wherein the quantized data is obtained in the following steps:
inserting a first detection device having a first contact housing into the spindle, detecting the first contact housing with a sensor of the first detection device, and obtaining a first deformation, wherein the first contact housing and a connecting surface of the spindle have a first contact ratio;
inserting a second detection device having a second contact housing into the spindle, detecting the second contact housing with a sensor of the second detection device, and obtaining a second deformation, wherein the second contact housing and the connecting surface of the spindle have a second contact ratio; and
forming the quantized data according to the first contact ratio, the first deformation, the second contact ratio, and the second deformation.

13. The detection method for the spindle of the machine tool as claimed in claim 11, wherein the contact ratios are equivalent values of the deformations.

14. The detection method for the spindle of the machine tool as claimed in claim 11, wherein the detection module obtains a determination signal according to the contact ratio.

15. The detection method for the spindle of the machine tool as claimed in claim 1, wherein the contact housing has a first chamber, and the first chamber has an inner surface, wherein the sensor is disposed in the first chamber and connected to the inner surface.

16. The detection method for the spindle of the machine tool as claimed in claim 15, wherein the detection device further comprises a main housing connected to the contact housing, and the main housing has a second chamber communicated with the first chamber, wherein the process module is disposed in the second chamber and electrically connected to the sensor.
